(19) United States
(12) Patent Application Publication
(10) Pub. No.: US 2011/0048607 A1
(43) Pub. Date: Mar. 3, 2011

(54) PNEUMATIC TIRE

(76) Inventors: Hideki Seto, Hiratsuka-shi (JP); Ryoji Hanada, Hiratsuka-shi (JP)

(21) Appl. No.: 12/871,279

(22) Filed: Aug. 30, 2010

(30) Foreign Application Priority Data
Sep. 1, 2009 (JP) 2009-201452

(51) Int. Cl. B60C 9/18

(52) U.S. Cl. 152/527; 152/526

(57) ABSTRACT

A pneumatic tire including a carcass layer mounted between a pair of bead portions, at least two layers of a belt layer disposed on an outer circumferential side of the carcass layer corresponding to a tread portion, and a belt reinforcing layer having a strip material including at least one fiber cord wrapped spirally in a tire circumferential direction on an outer circumferential side of the belt layers, wherein the belt reinforcing layer has a center portion reinforcing layer for reinforcing a center portion of the belt layers and edge portion reinforcing layers for reinforcing edge portions of the belt layers, the center portion reinforcing layer and the edge portion reinforcing layers are mutually separated, a width of the center portion reinforcing layer is from 5% to 25% of a width of a belt layer having a smallest width, and a width of the edge portion reinforcing layers is from 10% to 35% of the width of the belt layer having the smallest width.

### PRIORITY CLAIM

This application is based upon and claims the benefit of priority from Japanese Patent Application No. 2009-201452, filed Sep. 1, 2009, the entire contents of which is incorporated herein by reference.

### BACKGROUND

1. Technical Field

The present disclosure relates to a pneumatic tire provided with a belt reinforcing layer formed by spirally wrapping a strip material including at least one fiber cord in a tire circumferential direction on an outer circumferential side of belt layers in a tread portion. More specifically, the present disclosure relates to a pneumatic tire that makes possible an effective reduction of rolling resistance.

2. Related Art

Conventionally, belt reinforcing layers formed by spirally wrapping a strip material including organic fiber cords such as nylon fiber cords, or the like, in a tire circumferential direction on an outer circumferential side of belt layers in a tread portion have been disposed in pneumatic tires. Rising of belt layers due to centrifugal force during high-speed running can be suppressed and high-speed durability can be improved by providing such a belt reinforcing layer on the outer circumferential side of the belt layers.

However, in recent years, due to an increasing recognition of environmental issues, there has been demand for a reduction of the rolling resistance of tires. Tire deformation during tire running due to hysteresis loss has a large effect on rolling resistance. Hysteresis loss can be determined by breaking down a tire into its various components, calculating a product of a strain energy density, volume, and energy loss ratio of each component, and combining that product across an entirety of the tire. Therefore, generally, rolling resistance increases as the strain on the tire increases and also rolling resistance increases as the volume of the tire increases.

Deformation accompanying ground contact has a large effect on strain during tire running. There may also be strain resulting from the rising of the belt layers accompanying an increase in centrifugal force during high-speed rotation. In fact, there is a tendency for rolling resistance to increase as speed increases. Therefore, rolling resistance can be reduced by suppressing deformation caused by the rising of the belt layers. However, the volume of the tire will increase if a disposed area or a number of laminated layers of the belt reinforcing layer is simply increased in order to suppress the rising of the belt layers. Therefore, suppression of the rising of the belt layers does not necessarily lead to a reduction in rolling resistance.

### SUMMARY

According to one aspect of the present disclosure, a pneumatic tire includes a carcass layer mounted between a pair of bead portions, at least two layers of a belt layer disposed on an outer circumferential side of the carcass layer in a tread portion, and a belt reinforcing layer formed by spirally wrapping a strip material including at least one fiber cord in a tire circumferential direction on an outer circumferential side of the belt layers, wherein the belt reinforcing layer includes a center portion reinforcing layer for reinforcing a center portion of the belt layers and edge portion reinforcing layers for reinforcing edge portions of the belt layers, the center portion reinforcing layer and the edge portion reinforcing layers are mutually separated, a width of the center portion reinforcing layer is from 5% to 25% of a width of a belt layer having a smallest width, and a width of the edge portion reinforcing layers is from 10% to 35% of the width of the belt layer having the smallest width.

In the present disclosure, because a center portion reinforcing layer and edge portion reinforcing layers, which are mutually separated, constitute a belt reinforcing layer, rising of belt layers can be suppressed while keeping an increase in the material of the belt reinforcing layer to a minimum. Therefore, rolling resistance can be effectively reduced. In other words, conventional belt reinforcing layers are generally only disposed either across an entirety of the belt layer or in regions corresponding to edge portions. When disposed across an entirety of the belt layer, the increase in the material needed for the belt reinforcing layer becomes great, and when disposed only in the regions corresponding to the edge portions of the belt layer, rising of a center portion of the belt layer cannot be suppressed. In both cases, an effect of reducing rolling resistance is low. In comparison, when the center portion reinforcing layer and the edge portion reinforcing layers constituting the belt reinforcing layer are mutually separated as in the present disclosure, an increase in the volume of the tire caused by the belt reinforcing layer is reduced and deformation of the tire is reduced. Therefore, the effect of reducing rolling resistance is high.

The width of the strip material is preferably from 1 mm to 5 mm. If the width of the strip material is too large, when the strip material S is spirally wrapped in the tire circumferential direction, the fiber cords will become inclined with respect to the tire circumferential direction and the strip material can become easily distorted along with the rising of the belt layers. This will result in increased strain on the tire and become a factor that negatively affects rolling resistance. However, distortion of the strip material can be suppressed by setting the width of the strip material to the aforementioned range. Additionally, in order to suppress the distortion of the strip material, it is preferable that the wrapping direction of the strip material be a same direction for the center portion reinforcing layer and the edge portion reinforcing layers.

It is preferable that contraction percentages of the fiber cords of the center portion reinforcing layer and the edge portion reinforcing layers when removed from the tire are from 0% to 3%, respectively. In other words, it is preferable that the fiber cords of the center portion reinforcing layer and the edge portion reinforcing layers be under a slight amount of tension in the tire. Particularly, it is preferable that the contraction percentage of the fiber cords of the center portion reinforcing layer when removed from the tire is greater than the contraction percentage of the fiber cords of the edge portion reinforcing layers and that a difference between the contraction percentage of the fiber cords of the center portion reinforcing layer when removed from the tire and the contraction percentage of the fiber cords of the edge portion reinforcing layers when removed from the tire is 1% or less. As a result, deformation of the tire during rotation can be effectively suppressed because a maximum fastening effect via the belt reinforcing layer can be exerted on the center portion and edge portions of the belt layers.

Particularly, it is preferable that nylon fiber cords are used as the fiber cords that constitute the center portion reinforcing layer, and that organic fiber cords, which have a higher elastic modulus than the nylon fiber cords, are used as the fiber cords that constitute the edge portion reinforcing layers. More specifically, it is preferably that the elastic modulus of the fiber cords that constitute the edge portion reinforcing layers is from 100 cN/dtex to 200 cN/dtex. Furthermore, it is preferable that a product of the elastic modulus and a count per unit width of the fiber cords that constitute the edge portion reinforcing layers is at least 25% greater than a product of the elastic modulus and a count per unit width of the fiber cords that constitute the center portion reinforcing layer. As a result, deformation of the tire accompanying rotation can be effectively suppressed.

In the present disclosure, the elastic modulus of the fiber cords was measured according to using the initial tensile resistance degree measurement conditions stipulated in Japanese Industrial Standard (JIS) L1017. Additionally, the contraction percentage of the fiber cords when removed from the tire was calculated according to the following formula: ε=(L0−L1)/L0×100%; wherein ε (%) was the contraction percentage, L0 (mm) was a length of the fiber cords in the tire, and L1 was a length of these fiber cords when removed from the tire. Note that when measuring the contraction percentage it is preferable that the fiber cord measured be 300 mm. In other words, it is preferable that L0=300 mm. Additionally, when measuring the length L1, a load of 1/20 g/dtex of a nominal fineness is applied to the fiber cord.

### BRIEF DESCRIPTION OF THE DRAWING

FIG. 1 is a meridian cross-sectional view showing a pneumatic tire according to an embodiment of the present disclosure.

### DETAILED DESCRIPTION

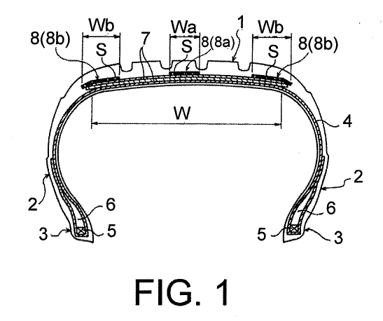

Detailed descriptions will be given below of a configuration of the present disclosure with reference to the accompanying drawings. FIG. 1 shows a pneumatic tire according to a first embodiment of the present disclosure. In FIG. 1, 1 is a tread portion; 2 is a sidewall portion; and 3 is a bead portion. A carcass 4 is mounted between the pair of left and right bead portions 3,3 and ends of the carcass layer 4 are folded around bead cores 5 from a tire inner side to a tire outer side. A bead filler 6 is disposed on the bead cores 5 and the bead filler 6 is sandwiched between a main body part and the folded over part of the carcass 4.

A plurality of layers of a belt layer 7 is embedded on an outer circumferential side of the carcass 4 corresponding with the tread portion 1. These belt layers 7 include a plurality of reinforcing cords that incline with respect to a tire circumferential direction and the reinforcing cords are disposed between the layers so as to intersect each other. A cord angle of the reinforcing cords of the belt layers 7 with respect to the tire circumferential direction is set so as to be in a range from 10 degrees to 40 degrees. Preferably, steel cords are used as the reinforcing cords of the belt layers 7 but organic fiber cords such as aramid fiber cords and the like can also be used.

A belt reinforcing layer 8 including fiber cords oriented in the tire circumferential direction is disposed on the outer circumferential side of the belt layers 7 for the purpose of improving high-speed durability. The belt reinforcing layer 8 has a jointless structure and comprises a strip material S spirally wrapped in the tire circumferential direction. The strip material comprises at least one rubber coated fiber cord. A cord angle of the belt reinforcing layer 8 with respect to the tire circumferential direction is 5 degrees or less and more preferably 3 degrees or less.

The belt reinforcing layer 8 is composed of a center portion reinforcing layer 8a for reinforcing a center portion of the belt layers 7 and edge portion reinforcing layers 8b, 8b for reinforcing edge portions of the belt layers 7. The center portion reinforcing layer 8a and the edge portion reinforcing layers 8b are disposed so as to be mutually separated. A width Wa of the center portion reinforcing layer 8a is set so as to be in a range from 5% to 25% and more preferably from 5% to 20% of a width W of a belt layer 7 having a smallest width. A width Wb of the edge portion reinforcing layers 8b is set so as to be in a range from 10% to 35% and more preferably from 10% to 30% of a width W of the belt layer 7 having the smallest width.

By configuring the belt reinforcing layer 8 from the center portion reinforcing layer 8a and the edge portion reinforcing layers 8b, which are mutually separated, and suppressing the belt layers 7 at three separate locations in the tire width direction, rising of the belt layers 7 can be suppressed while keeping an increase in the material of the belt reinforcing layer 8 to a minimum. Thus, an increase in the volume of the tire caused by the belt reinforcing layer 8 is reduced and deformation of the tire is reduced. Therefore, rolling resistance can be effectively reduced.

It is desirable to set the width Wa of the center portion reinforcing layer 8a so as to be within the aforementioned range. If the width Wa is too small, it will be difficult to suppress rising of the center portion of the belt layers 7, and conversely if the width Wa is too large, the reduction effect of rolling resistance will be negatively affected due to an increase in material. As an actual number, the width Wa of the center portion reinforcing layer 8a is preferably in a range from 15 mm to 40 mm.

It is desirable to set the width Wb of the edge portion reinforcing layers 8b so as to be within the aforementioned range. If the width Wb is too small, it will be difficult to suppress rising of the edge portions of the belt layers 7, and conversely if the width Wb is too large, the reduction effect of rolling resistance will be negatively affected due to an increase in material. As an actual number, the width Wb of the edge portion reinforcing layers 8b is preferably in a range from 20 mm to 50 mm.

In the pneumatic tire described above, a width of the strip material S is in a range from 1 mm to 5 mm. Thereby, a distortion of the strip material S can be suppressed and rolling resistance can be reduced. If the width of the strip material S exceeds 5 mm, when the strip material S is spirally wrapped in the tire circumferential direction, the fiber cords will become inclined with respect to the tire circumferential direction and the strip material S become easily distorted along with the rising of the belt layers 7. This will result in increased strain on the tire and become a factor that negatively affects rolling resistance. Additionally, making the width of the strip material S less than 1 mm is practically impossible.

A wrapping direction of the strip material S can be selected as necessary for each layer because the center portion reinforcing layer 8a and the edge portion reinforcing layers 8b that constitute the belt reinforcing layer 8 are mutually separated. However, if the wrapping direction of the strip material S differs between the center portion reinforcing layer 8a and the edge portion reinforcing layers 8b, the strip material S will become easily distorted. Therefore, in order to suppress the distortion of the strip material S, it is preferable that the wrapping direction of the strip material S be a same direction for the center portion reinforcing layer 8a and the edge portion reinforcing layers 8b.

In the pneumatic tire described above, contraction percentages of the fiber cords of the center portion reinforcing layer 8a and the edge portion reinforcing layers 8b when removed from the tire are set to be in a range from 0% to 3%, respectively. In conventional pneumatic tires, the contraction percentages of center portions and edge portions in belt reinforcing layers differ greatly. Particularly, in the edge portions, there are cases when the contraction percentage is a negative value. Specifically, in conventional tires, while a belt layer and a belt reinforcing layer are molded using a molding drum that has a uniform outer diameter along a drum axial direction, an outer diameter in a vicinity of the edge portions is smaller than an outer diameter in a vicinity of the center portion in a finished tire product, and therefore a contracting force acts on a circumferential length of the belt reinforcing layer during a molding process.

In comparison, with the pneumatic tire of the present disclosure, the belt layers 7 and belt reinforcing layer 8 are, for example, molded using a molding drum that has an outer circumferential surface with a curvature so that an outer diameter gradually gets smaller approaching both outer sides from the center portion in the drum axial direction. Thereby, the contraction percentage of the fiber cords of the center portion reinforcing layer 8a and the edge portion reinforcing layers 8b when removed from the tire are set to be in a range from 0% to 3%, respectively. As a result, deformation of the tire accompanying rotation can be effectively suppressed because a maximum fastening effect via the belt reinforcing layer 8 can be exerted on the center portion and edge portions of the belt layers 7. The effect of suppressing the tire deformation declines when the contraction percentage is outside the range of from 0% to 3%.

When forming the belt reinforcing layer 8 on a molding drum having a curvature as described above, using strip materials S with large width will lead to difficulties in realizing uniform tension of the fiber cords. In other words, when wrapping a strip material S with a large width on the outer circumferential surface of the molding drum having a curvature a portion of the fiber cords of the width direction of the strip material S will be under a great amount of tension and the rest of the fiber cords will be under almost no tension due to the curvature of the outer circumferential surface. From this perspective, it is preferable that the width of the strip material S is 5 mm or less and that the tension that the fiber cords is under be made uniform.

It is favorable that the contraction percentage of the fiber cords of the center portion reinforcing layer 8a when removed from the tire is greater than the contraction percentage of the fiber cords of the edge portion reinforcing layers 8b when removed from the tire. Additionally, it is favorable that a difference between the contraction percentage of the fiber cords of the center portion reinforcing layer 8a when removed from the tire and the contraction percentage of the fiber cords of the edge portion reinforcing layers 8b when removed from the tire is 1% or less. As a result, deformation of the tire accompanying rotation can be further effectively suppressed because a maximum fastening effect via the belt reinforcing layer 8 can be exerted on the center portion and edge portions of the belt layers 7.

The fiber cords used in the belt reinforcing layer 8 are not particularly limited, and various types of organic fiber cords can be used. Particularly, it is favorable that nylon fiber cords are used as the fiber cords that constitute the center portion reinforcing layer 8a and organic fiber cords, which have a higher elastic modulus than the nylon fiber cords, are used as the fiber cords that constitute the edge portion reinforcing layers 8b. In other words, nylon fiber cords are preferable as the fiber cords that constitute the center portion reinforcing layer 8a because they conform to expansion during tire molding. On the other hand, organic fiber cords that have a higher elastic modulus than the nylon fiber cords are preferable as the fiber cords that constitute the edge portion reinforcing layers 8b because they effectively suppress tire deformation. It is favorable that the elastic modulus of the fiber cords that constitute the edge portion reinforcing layers 8b is from 100 cN/dtex to 200 cN/dtex.

Examples of such organic fiber cords include aramid fiber cords, polyethylene naphthalate fiber cords (PEN), polyolefin ketone fiber cords (POK), lyocell fiber cords, polyethylene terephthalate fiber cords (PET), and the like. Additionally, hybrid cords of aramid fiber and nylon fiber, for example, may be used.

Furthermore, it is favorable that a product of the elastic modulus (cN/dtex) and a count per unit width of the fiber cords (cords/50 mm) that constitute the edge portion reinforcing layers 8b is at least 25% greater than a product of the elastic modulus (cN/dtex) and a count per unit width of the fiber cords (cords/50 mm) that constitute the center portion reinforcing layer 8a. In other words, it is preferable that a fastening effect of the edge portion reinforcing layers 8b be relatively increased. As a result, deformation of the tire accompanying rotation can be effectively suppressed.

### EXAMPLES

Tires of Comparative examples 1 to 3 and Examples 1 to 9, each having a tire size of 195/65 R15, were manufactured. The pneumatic tires included a carcass layer mounted between a pair of bead portions, two layers of a belt layer disposed on an outer circumferential side of the carcass layer corresponding to a tread portion, and a belt reinforcing layer formed by spirally wrapping a strip material including at least one fiber cord in a tire circumferential direction on an outer circumferential side of the belt layers, wherein the belt reinforcing layer includes a center portion reinforcing layer and edge portion reinforcing layers. Widths of the center portion reinforcing layer and the edge portion reinforcing layers, contraction percentages of the fiber cords of the center portion reinforcing layer and the edge portion reinforcing layers when removed from the tire, materials of the fiber cords of the center portion reinforcing layer and the edge portion reinforcing layers, widths of the strip material, and wrapping direction of the strip material were set as shown in Table 1 and Table 2.

In Table 1 and Table 2, a ratio of the widths of the center portion reinforcing layer and the edge portion reinforcing layers with respect to the width of the belt layer having smallest width (165 mm) is parenthetically noted. For the materials of the fiber cords, “N66” refers to a nylon fiber cord (940 dtex/2), and “N66+A” refers to a hybrid cord (A1670 dtex×2+N1400 dtex×1) of nylon fiber and aramid fiber.

Rolling resistance for these test tires was evaluated according to the following method and the results were recorded in Table 1 and Table 2.

### Rolling Resistance:

Each test tire was assembled on a wheel having a rim size of 15×6J, mounted on a drum tire rolling resistance tester, and rolling resistance was measured during running under the following conditions: air pressure=200 kPa, load=4.5 kN, speed=80 km/h. The evaluation results are shown as an index with comparative example 1 being 100. Smaller index values indicate less rolling resistance.

TABLE 1

| | CE 1 | CE 2 | CE 3 | Ex. 1 | Ex. 2 | Ex. 3 |
|---|---|---|---|---|---|---|
| Width of center portion | — | 50 (30%) | 20 (12%) | 20 (12%) | 21 (13%) | 21 (13%) |
| reinforcing layer (mm) | | | | | | |
| Width of edge portion | 30 (18%) | 30 (18%) | 60 (36%) | 30 (18%) | 30 (18%) | 30 (18%) |
| reinforcing layers (mm) | | | | | | |
| Contraction percentage of | — | 3 | 3 | 3 | 3 | 3 |
| center portion reinforcing | | | | | | |
| layer cords (%) | | | | | | |
| Contraction percentage of | −1 | 1 | 1 | 1 | 1 | 1 |
| edge portion reinforcing | | | | | | |
| layer cords (%) | | | | | | |
| Material of center portion | N66 | N66 | N66 | N66 | N66 | N66 |
| reinforcing layer cords | | | | | | |
| Material of edge portion | N66 | N66 | N66 | N66 | N66 | N66 |
| reinforcing layer cords | | | | | | |
| Width of strip material (mm) | 10 | 10 | 10 | 10 | 3 | 3 |
| Wrapping direction of strip | Same | Same | Same | Same | Same | Center only |
| material | direction | direction | direction | direction | direction | reversed |
| Rolling resistance | 100 | 102 | 101 | 95 | 92 | 94 |

Notes to Table 1:
The abbreviations used in the column headings are as followings: “Ex.” is an abbreviation of “Example”; and “CE” is an abbreviation of “Comparative Example”

TABLE 2

| | Ex. 4 | Ex. 5 | Ex. 6 | Ex. 7 | Ex. 8 | Ex. 9 |
|---|---|---|---|---|---|---|
| Width of center portion | 20 (12%) | 20 (12%) | 21 (13%) | 20 (12%) | 20 (12%) | 21 (13%) |
| reinforcing layer (mm) | | | | | | |
| Width of edge portion | 30 (18%) | 30 (18%) | 30 (18%) | 30 (18%) | 30 (18%) | 30 (18%) |
| reinforcing layers (mm) | | | | | | |
| Contraction percentage of | 3 | 3 | 3 | 3 | 3 | 3 |
| center portion reinforcing | | | | | | |
| layer cords (%) | | | | | | |
| Contraction percentage of | 0 | 2 | 2 | 0 | 2 | 2 |
| edge portion reinforcing | | | | | | |
| layer cords (%) | | | | | | |
| Material of center portion | N66 | N66 | N66 | N66 | N66 | N66 |
| reinforcing layer cords | | | | | | |
| Material of edge portion | N66 | N66 | N66 | N66 + A | N66 + A | N66 + A |
| reinforcing layer cords | | | | | | |
| Width of strip material (mm) | 5 | 5 | 3 | 5 | 5 | 3 |
| Wrapping direction of strip | Same | Same | Same | Same | Same | Same |
| material | direction | direction | direction | direction | direction | direction |
| Rolling resistance | 95 | 92 | 90 | 94 | 91 | 89 |

Notes to Table 2:
The abbreviations used in the column headings are as followings: “Ex.” is an abbreviation of “Example”; and “CE” is an abbreviation of “Comparative Example”

As is clear from Table 1 and Table 2, compared to Comparative Example 1, the tires of Examples 1 to 9 showed reduced rolling resistance. Considering the tires of Comparative Examples 2 and 3, while the belt reinforcing layers constituted center portion reinforcing layers and edge portion reinforcing layers that were mutually separated, the dimensions thereof were not adequate, and therefore the reduction effect in rolling resistance could not be obtained.

What is claimed is:

1. A pneumatic tire comprising:
a carcass layer mounted between a pair of bead portions,
at least two layers of a belt layer disposed on an outer circumferential side of the carcass layer corresponding to a tread portion, and
a belt reinforcing layer comprising a strip material including at least one fiber cord wrapped spirally in a tire circumferential direction on an outer circumferential side of the belt layers, wherein
the belt reinforcing layer is comprised of a center portion reinforcing layer for reinforcing a center portion of the belt layers and edge portion reinforcing layers for reinforcing edge portions of the belt layers,
the center portion reinforcing layer and the edge portion reinforcing layers are mutually separated,
a width of the center portion reinforcing layer is from 5% to 25% of a width of a belt layer having a smallest width, and
a width of the edge portion reinforcing layers is from 10% to 35% of the width of the belt layer having the smallest width.

2. The pneumatic tire according to claim 1, wherein a width of the strip material is from 1 mm to 5 mm.

3. The pneumatic tire according to claim 1, wherein a winding direction of the strip material is a same direction for the center portion reinforcing layer and the edge portion reinforcing layers.

4. The pneumatic tire according to claim 1, wherein contraction percentages of the fiber cords of the center portion reinforcing layer and the edge portion reinforcing layers when removed from the tire are from 0% to 3%, respectively.

5. The pneumatic tire according to claim 4, wherein a contraction percentage of the fiber cords of the center portion reinforcing layer when removed from the tire is greater than a contraction percentage of the fiber cords of the edge portion reinforcing layers.

6. The pneumatic tire according to claim 4, wherein a difference between the contraction percentage of the fiber cords of the center portion reinforcing layer when removed from the tire and the contraction percentage of the fiber cords of the edge portion reinforcing layers when removed from the tire is 1% or less.

7. The pneumatic tire according to claim 1, wherein nylon fiber cords are used as the fiber cords that comprise the center portion reinforcing layer and organic fiber cords, which have a higher elastic modulus than the nylon fiber cords, are used as the fiber cords that comprise the edge portion reinforcing layers.

8. The pneumatic tire according to claim 7, wherein the elastic modulus of the fiber cords that comprise the edge portion reinforcing layers is from 100 cN/dtex to 200 cN/dtex.

9. The pneumatic tire according to claim 7, wherein a product of the elastic modulus and a count per unit width of the fiber cords that comprise the edge portion reinforcing layers is at least 25% greater than a product of the elastic modulus and a count per unit width of the fiber cords that comprise the center portion reinforcing layer.

10. The pneumatic tire according to claim 1, wherein the belt layer comprises a reinforcing cord having a cord angle set with respect to the tire circumferential direction in a range from 10 degrees to 40 degrees.

11. The pneumatic tire according to claim 10, wherein the reinforcing cord comprises a steel cord.

12. The pneumatic tire according to claim 11, wherein the reinforcing cord comprises an aramid fiber cord.

13. The pneumatic tire according to claim 1, wherein a cord angle of the at least one fiber cord in the belt reinforcing layer with respect to the tire circumferential direction is 5 degrees or less.

14. The pneumatic tire according to claim 13, wherein a cord angle of the at least one fiber cord in the belt reinforcing layer with respect to the tire circumferential direction is 3 degrees or less.

15. The pneumatic tire according to claim 1, wherein the width of the center portion reinforcing layer is from 5% to 20% of the width of the belt layer having the smallest width.

16. The pneumatic tire according to claim 1, wherein the width of the edge portion reinforcing layers is from 10% to 30% of the width of the belt layer having the smallest width

17. The pneumatic tire according to claim 1, wherein the width of the center portion reinforcing layer is from 15 mm to 40 mm.

18. The pneumatic tire according to claim 1, wherein the width of the edge portion reinforcing layer is from 20 mm to 50 mm.

19. The pneumatic tire according to claim 4, wherein the contraction percentage is calculated according to the formula: ε=(L0−L1)/L0×100%; wherein ε (%) is the contraction percentage, L0 (mm) is a length of the at least one fiber cord, and L1 is a length of the at least one fiber cord when removed from the pneumatic tire.

20. The pneumatic tire according to claim 1, wherein the belt reinforcing layer comprises a jointless structure.
